(19) United States
(12) Patent Application Publication
(10) Pub. No.: US 2008/0068190 A1
(43) Pub. Date: Mar. 20, 2008

(54) COMMUNICATION APPARATUS

(75) Inventor: Ruoh-Wen Chin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/684,012

(22) Filed: Mar. 9, 2007

(30) Foreign Application Priority Data
Sep. 20, 2006 (TW) 95134756

(51) Int. Cl. G08B 21/14

(52) U.S. Cl. 340/632

(57) ABSTRACT

A communication apparatus is provided. The communication apparatus includes a control module, a communication module, and an alcohol-vapor-concentration sensor. The communication is electrically connected with the control module. The alcohol-vapor-concentration sensor is electrically connected with the control module to detect and deliver an alcohol vapor concentration value to the control module. Therefore, it is convenient for users to perform an alcohol vapor concentration detection.

### CROSS-REFERENCE TO RELATED APPLICATION

This application claims the priority benefit of Taiwan application serial no. 95134756, filed on Sep. 20, 2006. All disclosure of the Taiwan application is incorporated herein by reference.

### BACKGROUND OF THE INVENTION

1. Field of Invention

The present invention relates to a communication apparatus and, more particularly, to an alcohol-vapor-concentration-detecting communication apparatus.

2. Description of the Related Art

It is hard to avoid drinking when having social intercourses. Many people drive after drinking too much at the dinner. It is easy to cause serious traffic accidents and casualties. On the other hand, after being inspected by the police, the driver will be fined a lot of money and penalized by law.

As a result, people can find alcohol-vapor-concentration sensors in the market now to help test themselves. An up-to-date alcohol-vapor-concentration sensor, such as a police alcohol-vapor-concentration sensor, has the function of detecting concentration of alcohol vapor only. However, an alcohol-vapor-concentration sensor is not a necessity (e.g. wallet, mobile phone, and so on). Therefore, the sensor adds additional burden to the person carrying it, and it is easy to forget bringing the sensor.

In addition, some drivers may forget to test the concentration of alcohol vapor due to being drunk, and some others test the alcohol concentration but the sensors cannot warn them due to limited functionality. Therefore, people such as the drivers' friends aside or relatives do not know whether the test results against the legal standard. Therefore, the conventional alcohol-vapor-concentration sensor still has the above disadvantages and has to be improved.

### SUMMARY OF THE INVENTION

The objective of the present invention is to provide a communication apparatus which helps people test the concentration of alcohol vapor.

To achieve the above-mentioned objective, the invention discloses a communication apparatus, which includes a control module, a communication module, and an alcohol-vapor-concentration sensor. The communication module is electrically connected with the control module. The alcohol-vapor-concentration sensor is electrically connected with the control module to detect and send an alcohol vapor concentration value to the control module.

In one embodiment of the invention, the communication apparatus may include a display module which is electrically connected with the control module to display the alcohol vapor concentration value.

In one embodiment of the invention, the communication module may include a short message sending unit to send a warning massage to at least one pre-established receive recipient when the alcohol vapor concentration value exceeds a standard level.

In one embodiment of the invention, the communication apparatus may include a warning light to notify by emitting light when the alcohol vapor concentration value exceeds a standard level.

In one embodiment of the invention, the communication apparatus may include a buzzer to make sound when the alcohol vapor concentration value exceeds a standard level.

In one embodiment of the invention, the communication module may include a loudspeaker to make sound when the alcohol vapor concentration value exceeds a standard level.

In one embodiment of the invention, the communication module may include a receiver, and the concentration of alcohol sensor is disposed beside the receiver.

In one embodiment of the invention, the control module may include a switch unit for a user to switch the alcohol-vapor-concentration sensor on or off.

In one embodiment of the invention, the alcohol-vapor-concentration sensor may include a switch for a user to switch the alcohol-vapor-concentration sensor on or off.

In one embodiment of the invention, the control module includes a switch unit to switch on the alcohol-vapor-concentration sensor when communication module starts communication, and switch off the alcohol-vapor-concentration sensor when the communication of the communication module ends.

To sum up, the communication apparatus of the present invention provides the function for detecting the concentration of the alcohol vapor without an extra alcohol vapor sensor. Furthermore, the communication apparatus of the present invention may provide a warning function, which can inform the users' friends and relatives the results of exceeding of standard alcohol vapor concentration level to prevent them from driving.

These and other features, aspects, and advantages of the present invention will become better understood with regard to the following description, appended claims, and accompanying drawings.

### BRIEF DESCRIPTION OF THE DRAWINGS

FIG. 1 is a block diagram showing the communication apparatus according to an embodiment of the invention.

FIG. 2 is a three-dimensional schematic diagram showing the communication apparatus shown in FIG. 1.

### DETAILED DESCRIPTION OF THE EMBODIMENT

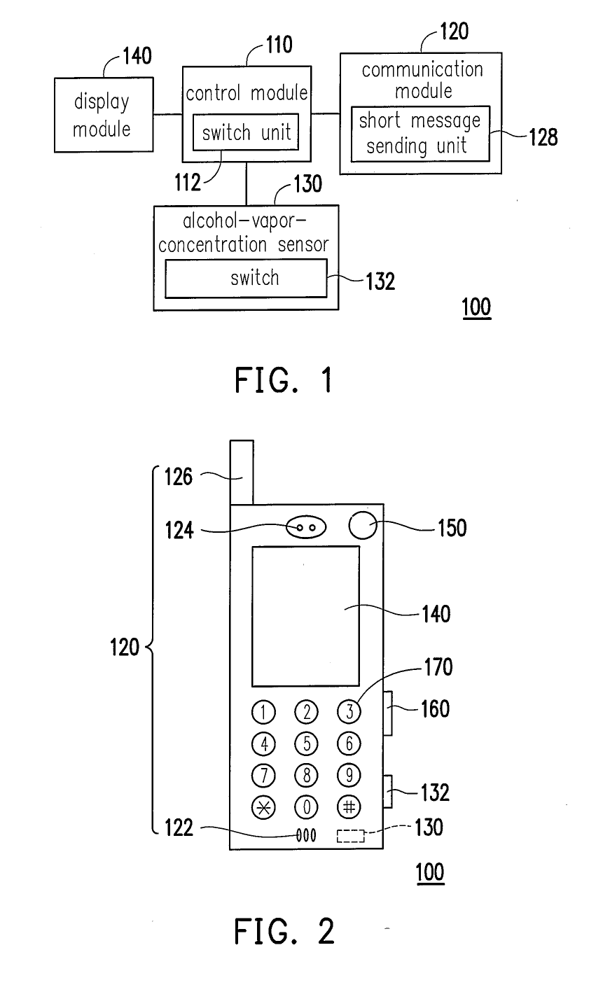

FIG. 1 is a block diagram showing the communication apparatus according to an embodiment of the invention, and FIG. 2 is a three-dimensional schematic diagram of the communication apparatus of FIG. 1. Referring to FIG. 1 and FIG. 2, the communication apparatus 100 includes a control module 110, a communication module 120, and an alcohol-vapor-concentration sensor 130. The communication apparatus 100 may be a mobile phone, a Personal Digital Assistant (PDA) handset, an intelligent handset, or other portable communication apparatus. The communication module 120 is electronically connected with the control module 110. The communication module provides communication functions of converting voice to electrical signals, transmitting the signals through communication network, and converting electrical signals received from communication network to voice. The alcohol-vapor-concentration sensor 130 is electrically connected with the control module 110 to detect and transmit an alcohol vapor concentration value to the control module 110. The alcohol-vapor-concentration sensor 130 may be a semiconductor sensor or other kinds of sensor.

In the embodiment of the invention, the communication module 120 may include a receiver 122, a speaker 124, and an antenna 126. The speaker 124 is used to convert electrical signals to voice, and the receiver 122 is used to convert voice to electrical signals. The antenna 126 is used to transmit and receive electrical signals through communication network. The alcohol-vapor-concentration sensor 130 is disposed beside the receiver 122 (as shown in FIG. 2) to get closer to the user's mouth during conversation to detect the concentration of alcohol vapor efficiently.

The control module 110 may include a switch unit 112 to switch on or off the alcohol-vapor-concentration sensor 130. The control module 110 may operate in many operation modes. For example, the switch unit 112 may automatically switch on the alcohol-vapor-concentration sensor 130 when the communication module 120 starts communication, and switch off the alcohol-vapor-concentration sensor 130 when the communication of the communication module 120 ends. Therefore, the communication apparatus 100 detects the alcohol vapor concentration immediately during a call.

Another operation mode of the switch unit 112 is to switch on or off the alcohol-vapor-concentration sensor 130 according to the command input by key pressing, handwriting, or voice from users. Therefore, users can switch on or off the alcohol-vapor-concentration sensor 130 manually at any time regardless of whether the communication module 120 starts its communication function. Users can test their own or other people's alcohol vapor concentration. The operation mode of the switch unit 112 mentioned above and that of other embodiments can be achieved by associating with proper software or firmware.

In one embodiment of the invention, the alcohol-vapor-concentration sensor 130 may include its own switch 132 (as shown in FIG. 2) to switch on and off the alcohol-vapor-concentration sensor 130. The switch 132 may be a hardware switch of the alcohol-vapor-concentration sensor 130. Therefore, user can switch on and off the alcohol-vapor-concentration sensor 130 directly using the switch 132.

The switch unit 112 or the switch 132 is not a necessary component of the communication apparatus 100. Therefore, the communication apparatus 100 may be provided with the switch unit 112, the switch 132, or both. The communication apparatus 100 can work without the switch unit 112 and the switch 132 while still keeping the alcohol-vapor-concentration sensor active so that the communication apparatus 100 can carry out the detection of alcohol vapor concentration at any time when it is active. With the switch 132, the alcohol-vapor-concentration sensor 130 still can be used when the communication apparatus 100 is off.

In one embodiment of the invention, the communication apparatus 100 may further include a warning light 150 and/or a buzzer 160. When the alcohol vapor concentration value exceeds a standard level, the warning light 150 emits light and/or the buzzer 160 makes sound for alerting purpose. According to the current Taiwanese laws, the standard level is 0.25 mg/l. The actual level set in the communication apparatus can be adjustable in view of the needs of different users.

The warning light may be a light emitting diode (LED), a bulb, or other appropriate light source. The buzzer 160 may make sounds like “Bi, Bi” or other simple tones. Furthermore, the communication module 120 may include a loudspeaker (not shown in the figures). When the alcohol vapor concentration value exceeds a standard level, the loudspeaker makes sound to warn the users and other people. In one embodiment of the invention, the loudspeaker is used to make sound of mobile ring tones or MP3 music. The sound from the loudspeaker may also be a simple tone, a polyphony ring, music, a recorded voice, and so on.

The communication apparatus 100 may provide the warning function by including the warning light 150, the buzzer 160 or the loudspeaker. Of course, the communication apparatus 100 may include all three of them, or only include one or two of them.

The warning light 150, buzzer 160, and loudspeaker mentioned above are used to alert users, users' relatives, or users' friends aside. In one embodiment of the invention, the communication apparatus 100 can send a short message to inform the relatives and friends who are not with the users. The communication module 120 may include a short message sending unit 128. When the alcohol vapor concentration value exceeds the standard level, the short message sending unit 128 sends a warning message to at least one pre-established recipient. The warning message can be sent by Short Message Service (SMS), Multi-media Message Service (MMS), email, or other type of message service. The pre-established recipient may be a mobile phone, an intelligent handset, a PDA handset, or a computer of the users' relative or friend. After the recipient is established, the communication apparatus 100 sends one or more warning short messages to users' relatives and friends if the test result exceeds the standard value.

Before sending the warning message, users can setup the contents of the warning message and the recipient. In details, users can input the warning message content by pressing key 170, handwriting, inputting voice, or choosing the built-in message in the communication apparatus 100. Users can setup the recipient by inputting an email address or a phone number, or choosing a stored phone number in the communication apparatus.

In one embodiment of the invention, the communication apparatus 100 further includes a display module 140, as shown in FIG. 2. The display module is electrically connected with the control module 110 to display the alcohol vapor concentration value. Therefore, users can obtain the alcohol vapor detection result.

To sum up, the communication apparatus has the function of detecting alcohol vapor concentration without carry an extra alcohol-vapor-concentration sensor. In addition, the communication apparatus may be used not only for the users themselves but also for their relatives and friends. Furthermore, the communication apparatus of the present invention provides warning function to inform the relatives and friends aside or send warning message to the others whom are not with users if the detect results exceeds standard level. It helps to prevent users drive after drink too much.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A communication apparatus, comprising:
a control module;
a communication module electrically connected to the control module; and
an alcohol-vapor-concentration sensor electrically connected to the control module for sending an alcohol vapor concentration value to the control module.

2. The communication apparatus according to claim 1, further comprising a display module electrically connected to the control module for displaying the alcohol vapor concentration value.

3. The communication apparatus according to claim 1, wherein the communication module comprises a short message sending unit for sending a warning message to at least one pre-established recipient when the alcohol vapor concentration value exceeds a standard level.

4. The communication apparatus according to claim 1, further comprising a warning light for warning by emitting light when the alcohol vapor concentration value exceeds a standard level.

5. The communication apparatus according to claim 1, further comprising a buzzer for making sound when the alcohol vapor concentration value exceeds a standard level.

6. The communication apparatus according to claim 1, wherein the communication module comprises a loudspeaker for making sound when the alcohol vapor concentration value exceeds a standard level.

7. The communication apparatus according to claim 1, wherein the communication module comprises a receiver and the alcohol-vapor-concentration sensor is disposed beside the receiver.

8. The communication apparatus according to claim 1, wherein the control module comprises a switch unit for a user to switch the alcohol-vapor-concentration sensor on or off.

9. The communication apparatus according to claim 1, wherein the alcohol-vapor-concentration sensor comprises a switch for a user to switch the alcohol-vapor-concentration sensor on or off.

10. The communication apparatus according to claim 1, wherein the control module comprises a switch unit for switching on the alcohol-vapor-concentration sensor when the communication module starts communication, and switch off the alcohol-vapor-concentration sensor when the communication of the communication module ends.
